(19) United States
(12) Patent Application Publication
(10) Pub. No.: US 2013/0185210 A1
(43) Pub. Date: Jul. 18, 2013

(54) Method and System for Making Digital Payments

(71) Applicant: The Board of Trustees of the Leland Stanford, Junr, Palo Alto, CA (US)

(72) Inventors: Benjamin Dodson, Los Gatos, CA (US); Daniel Boneh, Palo Alto, CA (US); Monica S. Lam, Menlo Park, CA (US)

(73) Assignee: The Board of Trustees of the Leland Stanford, Junior, University, Palo Alto, CA (US)

(21) Appl. No.: 13/657,710

(22) Filed: Oct. 22, 2012

Related U.S. Application Data
(60) Provisional application No. 61/550,347, filed on Oct. 21, 2011.

(51) Int. Cl. H04L 29/06; G06Q 20/40

(52) U.S. Cl. CPC H04L 63/08; G06Q 20/40
USPC 705/44; 726/7

(57) ABSTRACT

Among other things, the present disclosure describes an authentication system that leverage a mobile phone to improve the security of web logins and web payments on a personal computer. The described embodiments do not require special hardware beyond a cell phone with a camera. Using embodiments of the present invention, memorization of passwords is avoided and the login process is faster and less error-prone than with existing systems. In a payment system according to an embodiment, users do not need to let retailers keep their passwords because credit card information need to be manually input. In addition, the present invention allows users to conveniently take advantage of one-time use credit cards for additional security.

### CROSS-REFERENCE TO RELATED APPLICATIONS

This application claims priority to U.S. Provisional Application No. 61/550347 filed Oct. 21, 2011, which is hereby incorporated by reference in its entirety for all purposes.

### GOVERNMENT RIGHTS

This invention was made with Government support under contract 0832820 awarded by the National Science Foundation. The Government has certain rights in this invention.

### FIELD OF THE INVENTION

The present invention generally relates to computerized methods and systems for computer security.

### BACKGROUND OF THE INVENTION

Passwords are the predominant form of authentication system used on websites. This is not because the password system is the most secure; they are, in fact, known to have many problems. Passwords are vulnerable to dictionary attacks and can be obtained using a spoofed web site (e.g., phishing). For example, a breach at a large web site showed that close to 1% of users choose “123456” as their password. Moreover, since users tend to use the same password at many sites, a single server compromise can result in account takeover at many other sites. A single password has been found to be typically used to access over five sites. As more sites support email addresses as a username, this poses a significant risk—if an account is breached at one site, others are at risk as well. It has been found that on the order of 0.4% of users fall victim to a phishing attack each year. Despite these limitations passwords are widely used.

Over the years, many enhancements have been proposed, including smart cards, one-time password tokens (such as RSA SecurID) and challenge-response authentication. To date, none of these have been widely adopted on the web.

2

Regarding challenge-response, while it prevents some attacks that defeat basic passwords, it is rarely used on the web due to the cumbersome user experience. For example, a system called CRYPTOCard uses a smartcard with a screen and a keyboard where users key in the challenge and then copies the response to the desktop. Authentication using CRYPTOCard takes far longer than authentication using a simple password. As a result, CRYPTOCard is primarily used in corporate settings where the additional hardware cost and the extra inconvenience is acceptable.

The web has become the dominant platform for modern applications. One of the largest contributions to the web's success as a platform is the ability for users to visit a web page or application from a standard web browser such as found on many modern computers. Entering a unique name for a web application can be enough to download the necessary code and launch an application. A web application's authentication system must support this interaction—a user should be able to authenticate against a web application from any available browser, with no additional configuration. In particular, the authentication mechanism is restricted to using generic browser components combined with information supplied by the user.

Therefore, there is a need for a tool for improved security on the web in light of current trends in technology.

### SUMMARY OF THE INVENTION

As embodiments of the present invention, the present disclosure describes consumer-friendly techniques that leverage a mobile phone to improve the security of web logins and web payments on a personal computer, for example. The described embodiments do not require special hardware beyond, for example, a cell phone or tablet computer with a camera. Using embodiments of the present invention, the memorization of passwords is avoided and the login process is faster and less error-prone than with existing systems such as one-time passwords. For example, consumers do not need to let retailers keep their passwords because it eliminates the credit card entry by hand. In addition, it allows users to conveniently take advantage of one-time use credit cards for additional security.

By leveraging a mobile device, an embodiment of the present invention improves security for web applications on a standard web browser, without pre-configuration. The phone is often with its user and is switched on. It is a personal device that is not often used by others. In fact, the phone is a preferred device for keeping personal, private, information. In other words, it can serve to identify the owner, and can be used as a second-factor authentication. Browsers on the PC, on the other hand, are not necessarily personal. A user may drift among browsers on different PCs, at home, at work, and on the road.

At a high level, the user experience using this embodiment of the present invention is as follows. The user navigates his PC browser to the login page of a web site. The login page displays a QR code containing a cryptographic challenge among other things. The user takes a picture of the QR code using his cell phone camera. A pre-shared secret key stored on the phone is used to compute a response to the cryptographic challenge which is then transmitted to the site via the cellular (or WiFi) network, for example. The web site checks the response and if it is verified, the site triggers the PC browser to successfully complete the login process and load secured pages. The use of both the phone and PC provides an added security benefit, as checking the co-location of these devices can mitigate man-in-the-middle attacks.

When shopping at an online retailer for the first time, a checkout page typically asks users to enter all of their information (e.g. credit card number, billing address, shipping address, etc.) before the transaction can complete. This step is generally cumbersome and can cause shopping cart abandonment. In addition, there is some risk in sending sensitive information to a relatively unknown retailer. Moreover, consumers are often faced with the dilemma of either letting the retailer keep their credentials hence increase the risk or suffering the inconvenience of having to enter their credit card information repeatedly.

To address some of these issues, another embodiment of the present invention is applied to submit the credit card number by taking a picture of a QR code, for example. There is no need for manual entry of credit card information, and consequently no need to let the web site retain credit card information. In addition, added security can be provided by combining this approach with one-time use credit card numbers.

Among other things, embodiments of the present invention include the following:
Consumer-friendly challenge-response authentication. Embodiments of the present invention can be easy to use, for example, substantially reducing user authentication to taking a picture of the QR code with a camera on their cell phones. A website displays a QR code that embeds a challenge. The cell phone sends the response to the challenge directly to the web server.
OpenID integration. An embodiment of the present invention implements a custom OpenID provider on a mobile client, such as on an iPhone or Android smart phone or tablet. In this embodiment, the OpenID provider can be used to log onto over 30,000 existing websites that currently use OpenID. Embodiments of the present invention can be implemented with minimal changes to legacy services. For example, no changes may be required on browsers with this embodiment.
One-time credit card integration. Another embodiment of the present invention uses one-time credit card numbers to implement a payment system providing some user privacy from online merchants. This embodiment can also be used to improve the security and usability of other systems, including the Verified by Visa or MasterCard SecureCode services, for example.
Ease of use. Embodiments of the present invention are easy to use and are preferred to existing mechanisms like RSA SecureID and CRYPTOCard.

Embodiments of the present invention include general techniques based on the ability to create a secure three-way connection between a server, a browser on a computer, and a smart phone. The browser connects to the server with a web page visit, which is then connected to the phone via a QR code that embeds a session key. This enables a server to engage in secure sessions with the browser and the phone simultaneously. The server acts as a secure message router between the phone and the browser.

These and other embodiments will be better understood by those of ordinary skill in the art upon an understanding of the present disclosure along with the included drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic view of a networked system on which the present invention can be practiced.

FIG. 2 is a schematic view of a computer system on which the present invention can be practiced.

FIG. 3 is a sequence diagram for creating an account according to an embodiment of the present invention.

FIG. 4 is a sequence diagram for logging in to a web application according to an embodiment of the present invention.

FIGS. 5A-C are screenshots of a browser implementing methods according to the present invention for user authentication.

FIG. 6 is a screenshot of a browser implementing methods according to an embodiment of the present invention for payment processing.

### DETAILED DESCRIPTION

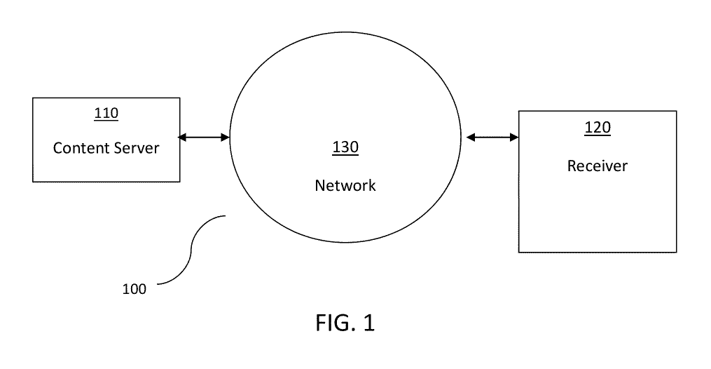

Among other things, the present invention relates to methods, techniques, and algorithms that are intended to be implemented in a digital computer system. By way of overview that is not intended to be limiting, digital computer system 100 as shown in FIG. 1 will be described. Such a digital computer or embedded device is well-known in the art and may include variations of the below-described system.

Those of ordinary skill in the art will realize that the following description of the present invention is illustrative only and not in any way limiting. Other embodiments of the invention will readily suggest themselves to such skilled persons, having the benefit of this disclosure. Reference will now be made in detail to specific implementations of the present invention as illustrated in the accompanying drawings. The same reference numbers will be used throughout the drawings and the following description to refer to the same or like parts.

Further, certain figures in this specification are flow charts illustrating methods and systems. It will be understood that each block of these flow charts, and combinations of blocks in these flow charts, may be implemented by computer program instructions. These computer program instructions may be loaded onto a computer or other programmable apparatus to produce a machine, such that the instructions which execute on the computer or other programmable apparatus create structures for implementing the functions specified in the flow chart block or blocks. These computer program instructions may also be stored in a computer-readable memory that can direct a computer or other programmable apparatus to function in a particular manner, such that the instructions stored in the computer-readable memory produce an article of manufacture including instruction structures which implement the function specified in the flow chart block or blocks. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flow chart block or blocks.

Accordingly, blocks of the flow charts support combinations of structures for performing the specified functions and combinations of steps for performing the specified functions. It will also be understood that each block of the flow charts, and combinations of blocks in the flow charts, can be implemented by special purpose hardware-based computer systems which perform the specified functions or steps, or combinations of special purpose hardware and computer instructions.

For example, any number of computer programming languages, such as C, C++, C# (C Sharp), Perl, Ada, Python, Pascal, SmallTalk, FORTRAN, assembly language, and the like, may be used to implement aspects of the present invention. Further, various programming approaches such as procedural, object-oriented or artificial intelligence techniques may be employed, depending on the requirements of each particular implementation. Compiler programs and/or virtual machine programs executed by computer systems generally translate higher level programming languages to generate sets of machine instructions that may be executed by one or more processors to perform a programmed function or set of functions.

The term “machine-readable medium” should be understood to include any structure that participates in providing data which may be read by an element of a computer system. Such a medium may take many forms, including but not limited to, non-volatile media, volatile media, and transmission media. Non-volatile media include, for example, optical or magnetic disks and other persistent memory. Volatile media include dynamic random access memory (DRAM) and/or static random access memory (SRAM). Transmission media include cables, wires, and fibers, including the wires that comprise a system bus coupled to processor. Common forms of machine-readable media include, for example, a floppy disk, a flexible disk, a hard disk, a magnetic tape, any other magnetic medium, a CD-ROM, a DVD, any other optical medium.

FIG. 1 depicts an exemplary networked environment 100 in which systems and methods, consistent with exemplary embodiments, may be implemented. As illustrated, networked environment 100 may include a content server 110, a receiver 120, and a network 130. The exemplary simplified number of content servers 110, receivers 120, and networks 130 illustrated in FIG. 1 can be modified as appropriate in a particular implementation. In practice, there may be additional content servers 110, receivers 120, and/or networks 130.

In certain embodiments, a receiver 120 may include any suitable form of multimedia playback device, including, without limitation, a computer, a gaming system, a smart phone, a tablet, a cable or satellite television set-top box, a DVD player, a digital video recorder (DVR), or a digital audio/video stream receiver, decoder, and player. A receiver 120 may connect to network 130 via wired and/or wireless connections, and thereby communicate or become coupled with content server 110, either directly or indirectly. Alternatively, receiver 120 may be associated with content server 110 through any suitable tangible computer-readable media or data storage device (such as a disk drive, CD-ROM, DVD, or the like), data stream, file, or communication channel.

Network 130 may include one or more networks of any type, including a Public Land Mobile Network (PLMN), a telephone network (e.g., a Public Switched Telephone Network (PSTN) and/or a wireless network), a local area network (LAN), a metropolitan area network (MAN), a wide area network (WAN), an Internet Protocol Multimedia Subsystem (IMS) network, a private network, the Internet, an intranet, and/or another type of suitable network, depending on the requirements of each particular implementation.

One or more components of networked environment 100 may perform one or more of the tasks described as being performed by one or more other components of networked environment 100.

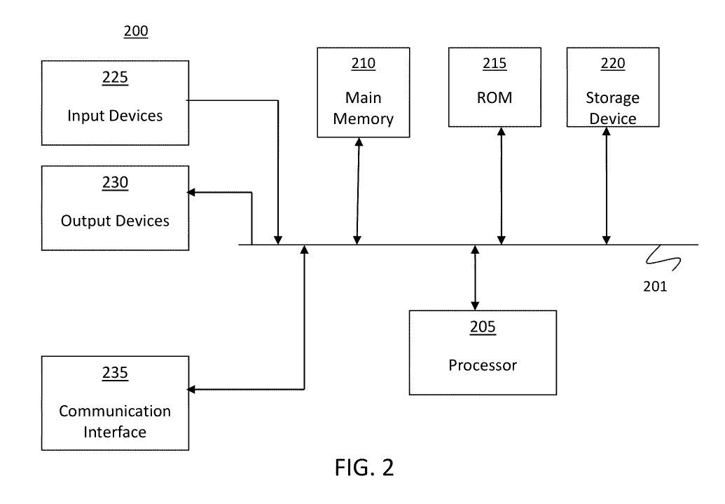

FIG. 2 is an exemplary diagram of a computing device 200 that may be used to implement aspects of certain embodiments of the present invention, such as aspects of content server 110 or of receiver 120. Computing device 200 may include a bus 201, one or more processors 205, a main memory 210, a read-only memory (ROM) 215, a storage device 220, one or more input devices 225, one or more output devices 230, and a communication interface 235. Bus 201 may include one or more conductors that permit communication among the components of computing device 200.

Processor 205 may include any type of conventional processor, microprocessor, or processing logic that interprets and executes instructions. Moreover, processor 205 may include processors with multiple cores. Also, processor 205 may be multiple processors. Main memory 210 may include a random-access memory (RAM) or another type of dynamic storage device that stores information and instructions for execution by processor 205. ROM 215 may include a conventional ROM device or another type of static storage device that stores static information and instructions for use by processor 205. Storage device 220 may include a magnetic and/or optical recording medium and its corresponding drive.

Input device(s) 225 may include one or more conventional mechanisms that permit a user to input information to computing device 200, such as a keyboard, a mouse, a pen, a stylus, handwriting recognition, voice recognition, biometric mechanisms, and the like. Output device(s) 230 may include one or more conventional mechanisms that output information to the user, including a display, a projector, an A/V receiver, a printer, a speaker, and the like. Communication interface 235 may include any transceiver-like mechanism that enables computing device/server 200 to communicate with other devices and/or systems. For example, communication interface 235 may include mechanisms for communicating with another device or system via a network, such as network 130 as shown in FIG. 1.

Computing device may include a computer, a gaming system, a smart phone, a tablet, a cable or satellite television set-top box, a DVD player, a digital video recorder (DVR), or a digital audio/video stream receiver, decoder, and player. As will be described in detail below, computing device 200 may perform operations based on software instructions that may be read into memory 210 from another computer-readable medium, such as data storage device 220, or from another device via communication interface 235. The software instructions contained in memory 210 cause processor 205 to perform processes that will be described later. Alternatively, hardwired circuitry may be used in place of or in combination with software instructions to implement processes consistent with the present invention. Thus, various implementations are not limited to any specific combination of hardware circuitry and software.

A web browser comprising a web browser user interface may be used to display information (such as textual and graphical information) on the computing device 200. The web browser may comprise any type of visual display capable of displaying information received via the network 130 shown in FIG. 1, such as Microsoft's Internet Explorer browser, Google's Chrome browser, Mozilla's Firefox browser, PalmSource's Web Browser, Google's Chrome browser or any other commercially available or customized browsing or other application software capable of communicating with network 130. The computing device 200 may also include a browser assistant. The browser assistant may include a plug-in, an applet, a dynamic link library (DLL), or a similar executable object or process. Further, the browser assistant may be a toolbar, software button, or menu that provides an extension to the web browser. Alternatively, the browser assistant may be a part of the web browser, in which case the browser would implement the functionality of the browser assistant.

The browser and/or the browser assistant may act as an intermediary between the user and the computing device 200 and/or the network 130. For example, source data or other information received from devices connected to the network 130 may be output via the browser. Also, both the browser and the browser assistant are capable of performing operations on the received source information prior to outputting the source information. Further, the browser and/or the browser assistant may receive user input and transmit the inputted data to devices connected to network 130.

Similarly, certain embodiments of the present invention described herein are discussed in the context of the global data communication network commonly referred to as the Internet. Those skilled in the art will realize that embodiments of the present invention may use any other suitable data communication network, including without limitation direct point-to-point data communication systems, dial-up networks, personal or corporate Intranets, proprietary networks, or

### System Overview

Embodiments of the present invention include authentication systems designed for ease of use while providing stronger security than traditional passwords or one-time passwords. Certain embodiments of the present invention is intended to protect against the following types of adversaries:
Phishing. Phishing targets users who ignore the information presented in the browser address bar. A phishing attacker sets up a spoof of a banking site and tries to fool the user into authenticating at the spoofed site. Furthermore, an embodiment of the present invention allows for online phishing where the phishing site plays a man-in-the-middle between the real banking site and the user. The phisher can wait for authentication to complete and then hijack the session. One-time-password systems, such as SecurID over SSL, cannot defend against online phishing. Using embodiments of the present invention, this attack is considerably harder.
Network attacks. In a threat model, the attacker is allowed to passively eavesdrop on any network traffic. Moreover, the attacker may be able to perform a wide class of active network attacks.
Mobile client theft. Embodiments of the present invention enable quick revocation in case a mobile client (e.g., smart phone or tablet) is stolen.

In still other embodiments of the present invention, security is provided against malware on the user's machine. In yet another embodiment, protection is provided against malware on the phone itself

Certain core algorithms in an embodiment of the present invention will be described. Recall that challenge-response authentication is generally implemented in two forms. The first is a system based on symmetric cryptography. Such an implementation uses little CPU power and generates very short messages but requires that the server possess the user's secret authentication key. As a result, the user must maintain a different secret key for each server where she has an account. The second implementation is a system based on public-key cryptography. This implementation requires considerably more CPU power to generate responses to challenges, but the server only needs to keep the user's public-key. As a result, the same user secret key can be used to authenticate with many servers.

Both challenge-response systems as implemented in embodiments of the present invention are described. The basic work flow is presented, including account creation, login, and revocation.

### Symmetric Key Challenge Response Authentication

In a symmetric key based challenge-response implementation, the client(s) and web server communicate using a pre-shared secret key. An embodiment uses a key length of 128 bits. This key is used in the HMAC-SHA1 algorithm to compute responses to server-issued challenges. The challenges are 128-bit length nonces embedded in a QR code, while the responses are 160 bits long and are sent over the wireless network.

### Account Creation

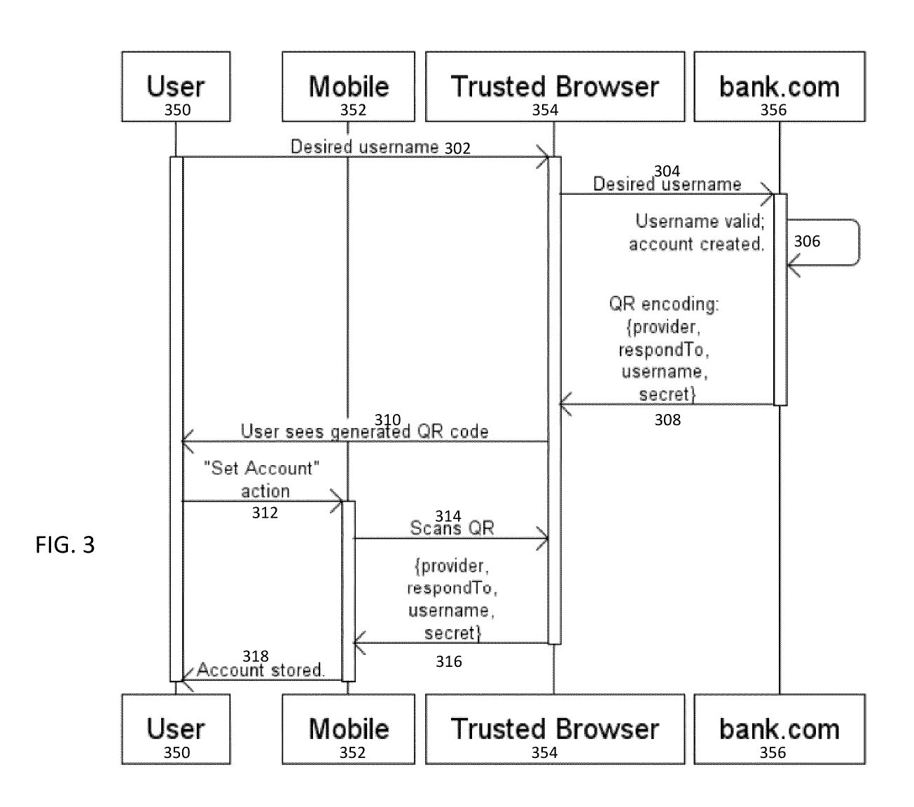

Shown in FIG. 3 is a method for creating an account according to an embodiment of the present invention. It should be noted that the described embodiments are illustrative and do not limit the present invention. It should further be noted that the method steps need not be implemented in the order described. Indeed, certain of the described steps do not depend from each other and can be interchanged. For example, as persons skilled in the art will understand, any system configured to implement the method steps, in any order, falls within the scope of the present invention.

In an embodiment, an account creation web page invites a new user to submit a username at step 302. The desired user name is then transmitted from the browser 354 to secure server 356 (e.g., a bank server). Upon receiving an acceptable username, server 356 creates an account at step 306. Server 356 generates a shared secret for the account and sends such shared secret to browser 354 as a QR code at step 308. In an embodiment, the QR code includes encoded account information such as provider, a ResponseTo message, a username, and a secret.

For example, in an embodiment of the present invention that is implemented using, among other things, an Android phone and associated QR reader, for example, a QR code is created at step 308 that represents a created account by encoding the following contents:

{ protocol: “V3”,
provider: “goodbank.com”,
respondTo: “https://login.goodbank.com/response”,
username: “mr_rich”,
secret: “2934bab43cd29f23a9ea”
}

While this embodiment is described using QR codes, many other embodiments are possible. For example, other encoding schemes can be implemented such as bar codes other codes as may be developed in the future.

At step 310, the user sees the QR code appear on browser 354. Responsively, the user launches a client application on his smart phone, for example, according to an embodiment of the present invention. At step 312, the user initiates an account creation process on the client application by, for example, selecting a “Set Account” button on the client application. Responsively, the user's phone activate its camera so as to scan the QR code at step 314. At step 316, algorithms within the client application running on the user's phone decodes QR code information such as provider, a ResponseTo message, a username, and a secret. At this stage, a user can also provide other details using browser 354, including such details as full name, physical address, email address, etc. At step 318, the client application stores the corresponding account information for later use. In another embodiment, further security is provided by the client application 352 confirming account details with server 356. Secure server 356 can further confirm successful creation of the user's account. To avoid adding spurious entries in a server database, another embodiment includes a further user login requirement so as to complete the account creation process.

Note that this process eliminates the need for a user to create and remember a password, which is not just cumbersome but extremely insecure as discussed above. In an embodiment, it is not necessary for the user to have a friendly user name; but it is important for the sake of addressing and reassuring the user that the website recognizes him.

Instead of using a user-supplied password, a scheme as an embodiment of the present invention allows the web server to generate a random key as a shared secret between the web site and the user. The shared secret is presented in a QR code and saved on the phone's password manager once scanned. The user can present it for subsequent logins without needing to know its value. The QR code also specifies the endpoint where the phone will send responses to challenges as part of the login procedure.

In an embodiment, the account creation process can be performed entirely on the phone, without the need for an interaction between a browser and the phone. In an embodiment, this approach was not used because, during account creation, the user is often required to supply relatively many account details such as a physical address, email address, etc. Extensive typing on the phone can be cumbersome. Instead, in the embodiment of FIG. 3, the user enters all account details through browser 354 that may reside on a personal computer and uses a QR code to move corresponding credentials to the phone. These are design choices, however, that do not limit the scope of the present invention.

### Account Login

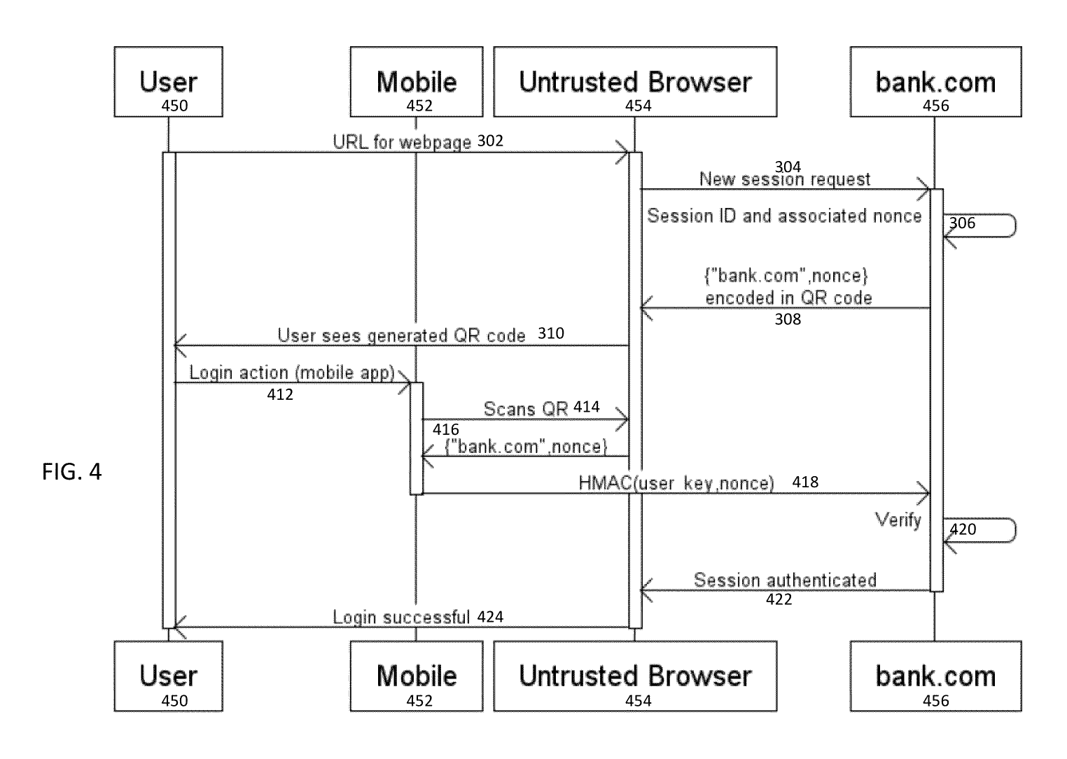

Shown in FIG. 4 is a method for logging into an account according to an embodiment of the present invention. It should be noted that the described embodiments are illustrative and do not limit the present invention. It should further be noted that the method steps need not be implemented in the order described. Indeed, certain of the described steps do not depend from each other and can be interchanged. For example, as persons skilled in the art will understand, any system configured to implement the method steps, in any order, falls within the scope of the present invention.

At step 402, a user enters a URL in browser 454 for a desired secure website, for example, a banking website. At step 404, the user makes an appropriate selection on a resulting web page (e.g., clicking on button) so as to initiate the login process according to an embodiment of the present invention. Responsively, at step 404, a new session request is transmitted from browser 454 to server 456. Server 456 then generates at step 406 a session ID and an associated nonce. A QR code is then generated and transmitted from server 456 to browser 454.

For example, in an embodiment, the QR code is unique on a per session basis. In an embodiment, the QR code encodes a random challenge nonce to be used in a symmetric challenge-response authentication. In an embodiment, this is presented within the context of an SSL session between the browser and the server. An example of the contents contained in a challenge QR code include:

{ protocol: “V3”,
provider: “goodbank.com”,
challenge: “59b239ab129ec93f1a”
}

By binding the challenge nonce to the browser session, the server ensures that only one browser session can make use of its authorization.

Upon viewing the QR code on browser 454 at step 410, the user initiates a mobile application such as an application running on the user's Android phone. The user then uses such application and an integrated camera to take a picture of the QR code at step 414. In an embodiment, the user is provided an alternative login method in case the user's phone is not available.

By using the integrated camera, the mobile application consumes the challenge QR code and extracts the challenge within it. For example, the mobile application extracts a shared secret key and response endpoint that match the provider name and desired user account. In an embodiment, the mobile application computes a response comprising an HMAC-SHA1 hash of the entire challenge message using the pre-shared secret as key and transmits such hash to server 456 at step 418. In an embodiment, the original challenge and account identifier are also transmitted. In an embodiment, the challenge and response flows occur within SSL sessions. Server 456 then verifies the response at step 420. Upon a successful verification, server 456 sends a session authenticated message to browser 454 for display. At step 424, the user consumes visual verification that a successful login has been completed.

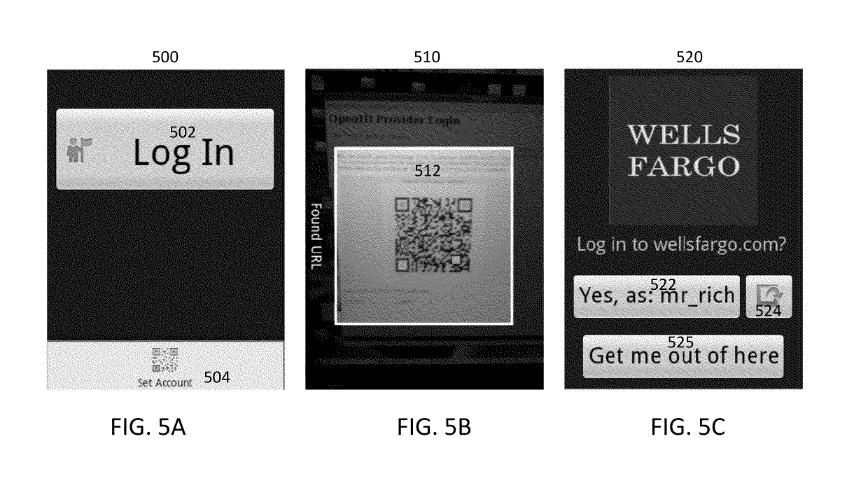

Shown in FIGS. 5A-C are screens that are used for logging into an account according to an embodiment of the present invention. For example, as shown in FIG. 5A, screen 502 is presented to a user on a browser. Button 502 can be selected to initiate the login process according to an embodiment of the present invention. Also, button 504 can be selected to initiate an account creation process such as was described with reference to FIG. 3. Responsive to selecting button 502, screen 510 of FIG. 5B is displayed on the browser. Screen 510 includes QR code 512 that has embedded within it certain account information. The user can then scan QR code 512 and separately communicate with the associated server. Upon successful account verification, such server can then cause to be displayed screen 520 as shown in FIG. 5C. Button 522 is provided so that the user can confirm successful verification of his credentials. If an improper verification occurred, however, button 225 is provided so as to exit screen 520.

### Public-key Based Challenge Response Authentication

Key proliferation is a prevalent issue with a challenge response system that utilizes symmetric keys. For example, the user may need to negotiate and manage a shared secret with each web site he visits. A public-key based challenge response system is described to address this issue as an embodiment of the present invention.

Instead of using symmetric keys, a mobile application according to an embodiment of the present invention can generate private/public key pair for the user upon installation (and, alternatively, on-demand). The account creation process is modified such that the user presents his public key to the web site instead of having the site generate a secret. The challenge process proceeds as before. The mobile application according to this embodiment generates a response by signing the challenge with the private key. The web server verifies the response by matching it against the user's public key. In this embodiment, the user's public key can be used across all the secured sites he wishes to visit.

There is an alternative solution to the key proliferation problem in symmetric challenge systems. In an embodiment, the user can take advantage of an OpenID provider and benefit from OpenID's single sign-on properties across multiple web sites. Thus, the user's mobile application according to an embodiment of the present invention maintains a single shared secret between the user and his OpenID provider. In this embodiment, the number of keys is limited to the number of OpenID providers that are used. A user may even use the same private/public key pair across his OpenID providers enabling this embodiment to maintain fewer keys. Many other variations are possible as would be understood by those of ordinary skill in the art.

Note that this protocol requires no certificate authority (CA) infrastructure. Client certificates are entirely avoided in either solution, while the first solution also avoids a CA. The OpenID-based solution is a centralized component necessary to enable an embodiment of the present invention to be used with unmodified websites while mitigating the key proliferation problem. The OpenID provider may use a CA; a scheme as an embodiment of the present invention interoperates with this design but does not require it.

### Supporting Multiple Websites

The use of a single mobile client according to an embodiment of the present invention will now be described for logging onto multiple websites, potentially with multiple personas, as an embodiment of the present invention. An embodiment of the present invention leverages OpenID to enable the adoption of this technology immediately across a large number of existing websites.

### Independent Accounts

In an embodiment, only one mobile client is carried on the phone to log onto multiple websites; variations are, of course, possible. The client according to an embodiment of the present invention maintains a mapping from providers to accounts. The mobile client may also maintain multiple accounts per provider, allowing the user to select their desired identity during a login attempt. The response message from the phone to the web site contains the user's identity that is logging in along with the corresponding cryptographic response.

To minimize the risk of phishing when implemented on multiple sites, an embodiment of the present invention associates a recognizable image with each web site, obtained at account creation time. The image is displayed on the phone during login.

### OpenID

An embodiment of the present invention is implemented as a custom OpenID provider. Many web sites today have adopted the use of OpenID, enabling single sign-on using their OpenID credentials. The key advantage is that the websites that support OpenID, known as relying parties, can enable a login without requiring any code changes on their end. The user's credentials reside with an OpenID provider that uses an embodiment of the present invention. This embodiment is used to log into several websites supporting the standard, including, for example: Slash-dot, ProductWiki, ccMixter, and LiveJournal. Upon entering an OpenID account name to the web site of a relying party, the web page automatically redirects the user to the login page of the OpenID provider. In an embodiment of the present invention, the OpenID provider presents the user with the a QR code, and the login process proceeds as described above. In an embodiment, once the login process completes, the OpenID provider signals the result to the relying party web site.

A benefit of embodiments of the present invention is their simple user interaction, for example, a user toned not type in any credentials at a participating website. But an initial step of an OpenID login is to type in the user's OpenID address, so they may log in using their chosen identity provider.

To address this issue, a modified version of challenge-response is used in another embodiment of the present invention. In this embodiment, the relying party is charged with creating the challenge. The mobile application sends its response to this challenge to a pre-configured identity provider, which then notifies the relying party of the transaction.

This embodiment of the present invention generally works as follows:
When a user visits a website (relying party), it generates and displays a QR code containing a challenge created by this relying party, as well as an endpoint for handling responses.
The mobile client computes the response to the embedded challenge and sends it to the user's pre-configured identity provider. The message also contains the reliant party's response endpoint.
The provider, possessing the user's shared secret, verifies the response and notifies the relying party using the given endpoint. It also forwards the username and challenge associated with the authentication attempt.
Finally, as in OpenID, the relying party verifies a token with the identity provider, using a shared secret. If the authentication is successful and this token is valid, the relying party notifies the user's browser of a successful login. The user's browser asynchronously waits for this response, and a page refresh completes the authentication.

### Payment Processing

A generalization of embodiments of the present invention can help with both usability and security of online payments. For example, an embodiment of the present invention functions as a digital wallet on the phone and interacts with the web site using QR codes. The user experience is first described assuming an application according to an embodiment of the present invention already has the user's payment information. The manner in which to automatically populate the phone with this data will also be explained.

When making payments with an embodiment of the present invention, the mobile application contacts the user's bank and requests a one-time credit card number specific to the current retailer. This greatly reduces the risk of giving out the credit card number to an unknown retailer. Moreover, it enhances user privacy since it is more difficult for the retailer to track the user via one-time credit card numbers. Combining this with other private browsing mechanisms gives the user a convenient way to shop online with improved privacy.

One-time credit card numbers greatly reduce the risks involved in giving a credit card number to an unknown retailer. While one-time credit card numbers were introduced some time ago, they have had limited use primarily due to the effort required to generate them. With a payment process according to an embodiment of the present invention, one-time credit card numbers can be built-in and generated automatically by the system. As a result, the system is highly effective for interacting with small retailers or other lesser known sites on the Internet.

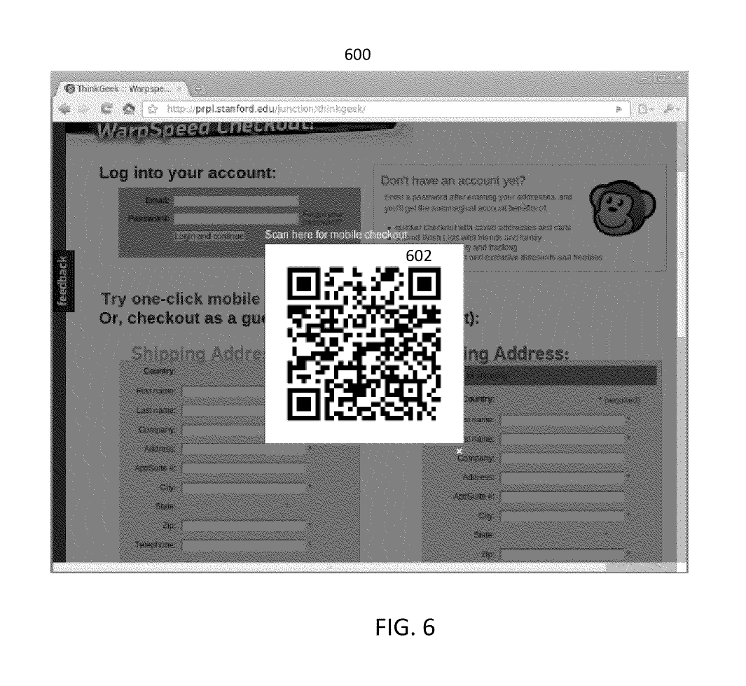

Using a payment process according to an embodiment of the present invention, the checkout process operates as follows:
When the user's browser arrives at the retailer's checkout page, the page displays a QR code encoding transaction details, in addition to normal shopping cart information. Shown in FIG. 6 is an exemplary checkout page 600 on which QR code 602 is displayed, wherein QR code 602 included encoded payment information according to an embodiment of the present invention. For example, the QR code encodes a response channel URL among other things.
Instead of manually entering personal information at the standard checkout page, the user can simply take a picture of the QR code using a mobile application according to an embodiment of the present invention.
Once the QR code is photographed, the user is asked to confirm the transaction on the mobile client. Next, the mobile client securely obtains a one-time credit card number from the user's bank specific to the retailer at issue.
Next, the phone contacts the response channel URL on the retailer's site and provides one-time payment information.
The retailer completes the transaction and redirects the user's browser to the transaction completion page.

The checkout process according to an embodiment of the present invention requires the user to a) take a picture of the checkout QR code and b) confirm the transaction on the phone. A reason for doing this on the phone (as opposed to in the browser) is mobility: the user's payment data is available to use on any computer and any browser. No special hardware or software is required on the personal computer in this embodiment.

To complete the discussion of payment processes according to embodiments of the present invention, the manner in which to populate the phone with the user's payment data is explained. Past experience with digital wallets (e.g. Microsoft's Digital Wallet) suggests users do not take the time to enter their payment information into the wallet. With an embodiment of the present invention, however, every time the user manually enters credit card information at an online retailer, the retailer displays a QR code containing such data. The user can simply take a picture of the QR code to bootstrap the payment database according to an embodiment of the present invention. Future transactions can use this data as explained above. This process can improve broad adoption of the present invention.

Verified by Visa and MasterCard SecureCode are, in effect, single sign-on services run by Visa and MasterCard, respectively, that let merchants obtain user confirmation on requested transactions. When a user visits a merchant's checkout page, the browser is redirected to the user's bank where the user is asked to confirm the transaction with a password. The browser is then redirected back to the merchant where the transaction completes, provided a valid confirmation token is supplied by the bank. The resulting transaction is considered a “card present” transaction which is a strong incentive for merchants to adopt this system. This architecture, however, is highly vulnerable to phishing and has, therefore, received much criticism.

Combining embodiments of the present invention such as user authentication and payment handling can improve the usability and security of existing systems such as Verified by Visa and MasterCard SecureCode. The mechanism is similar to how user authentication is integrated with OpenID as discussed above and works as follows in an embodiment:
In addition to standard transaction details, the merchant's checkout page includes a QR code that encodes the transaction amount plus a random challenge for a challenge-response protocol. The challenge also uniquely identifies the merchant.
The user takes a picture of the QR code with an application according to an embodiment of the present invention and approves the transaction on the phone. The phone then sends a message to the user's bank containing the transaction amount, the random challenge from the merchant, and the response to that challenge (computed using the user's secret key stored on the phone). The message also includes account information such as the user's credit card number. Note that the application according to an embodiment of the present invention is preconfigured at account setup to only send this message to the user's bank and nowhere else. Other variations are, however, possible.
The bank (in this example) checks that the challenge from the merchant and the response from the phone, both contained in the message from the phone, are valid. For example, the response from the phone is confirmed as a valid response for the challenge. If so, it uses a merchant response channel URL (e.g., a well-known endpoint) to send to the merchant the Verified by Visa confirmation token, which includes the random challenge contained in the message from the phone in addition to the standard fields.
The merchant verifies the token from the bank and also verifies that the challenge in the token is the challenge that the merchant supplied in the QR code—this verification is needed to ensure that the phone answered the correct challenge. If all is valid, the merchant completes the transaction and transitions the browser from the checkout page to the transaction completion page.

Using this approach the random challenge is provided by the merchant (e.g., in the QR code) but is verified by the bank. The improved user experience is generally as follows:
Take a picture of the QR code on the checkout page;
Confirm the transaction on the phone; and
Wait for the transaction to complete. Nothing needs to be entered and no confusing redirections take place.

Since the user never supplies a credential to the merchant, this embodiment prevents offline phishing by a malicious merchant. Online phishing may be possible, but a geolocation-based defense can improve security.

### Extensions

Several extensions of the present invention will now be discussed as alternative embodiments and as manners to improve security and to cope with scenarios when the user forgets his phone or forgets to log out. One of ordinary skill in the art will understand that these and other obvious extensions remain within the scope of the present invention.

In an alternative embodiment, a man-in-the-middle attack vector is minimized by using geolocation information of the phone relative to the user's computer. Recall that in user authentication, the target web site communicates with the user's computer and with the user's phone. In normal use, the two are in close proximity. In an online phishing attack, the site communicates with the phishing server and the user's phone. The two are very likely to be far apart. Advantageously, an embodiment of the present invention uses geolocation information to test if the IP addresses of the user's phone and computer are in close proximity. If so, the system allows the connection, and if not, it rejects the transaction. Thus, for the phisher to succeed, he must identify a victim's location, find a compromised host in close proximity to the victim, and place the phishing server there. While not impossible, in most phishing settings, this will be quite challenging for the phisher. Importantly, the phone's location measurement is not known to the web browser.

The above example works well when both the cell phone and user's computer are addressable, such as on WiFi or wired networks. Commercial systems such as Max-Mind offer geolocation databases claiming over 90 percent accuracy for resolving IP addresses to city locations. The cell phone, however, is often not addressable, frequently operating from the cellular provider's data network with an external gateway IP address. Cell phone IP addresses change frequently, and geographically diverse locations may operate under the same IP ranges. For example, a test user's Palo Alto, Calif., location may be resolved to one of T-Mobile's gateway IP addresses in Seattle, Wash. The user's phone aids the geolocation system by providing GPS or cell tower ID data at transaction time. Furthermore, a complimentary approach involves exploiting application latency measurements to disambiguate cities operating under the same IP address range within a cellular data network.

Reliance on the IP network may not be necessary in order to determine the phone's location, e.g., many modern platforms can provide applications with relatively accurate location information. Essentially, the phone will facilitate the authentication provider's tasks.

Another safeguard against the man in the middle is to require that sensitive transactions be verified on the mobile device. Here, the attacker gains access to the user's account and attempts to make a malicious transaction. The web site only allows this transaction to complete with confirmation from the phone, which the man in the middle cannot access. Using phones for transaction confirmation complements user authentication in an embodiment of the present invention.

Although users will typically have their phones with them, an additional login method allows users with missing phones to gain entry to a webpage. In an embodiment, this backup login method is treated as a password reset request. That is, to login without a phone requires solving a Captcha, responding to a selection of security questions, and retrieving a link sent to a primary email address.

In some cases, a user's phone may not have network connectivity, but is still available. Here, the phone displays a truncated version of the HMAC response, which the user enters directly into the webpage to complete the authentication.

It is difficult for a web site to know if a user has walked away from an authenticated session. In another embodiment, therefore, the phone can be used as a proximity sensor, powered by the device's location sensors or accelerometers. For example, when the phone detects motion above a threshold after authentication on the PC completes, it notifies the site. The site can then require re-authentication for subsequent requests. Thus, upon leaving an internet cafe, for example, the user's session is immediately terminated. For web users on a moving vehicle, for example, the site may request one re-authentication and subsequently ignore motion notifications from the phone for the duration of the session.

More generally, with an application according to an embodiment of the present invention, a user can manually log out of all of her active sessions from her mobile phone, without returning to the abandoned terminal.

### Security Analysis

A number of attacks on the system are described and the manner in which they are addressed using the present invention. Here, it is assumed that the login process and the subsequent session on the PC are served over SSL so that basic session hijacking (e.g., the attacker waits for authentication to complete and then hijacks the session) is not possible.

It is observed that with user authentication according to an embodiment of the present invention, unlike passwords, a compromise at one web site does not affect the user's account at other sites. To see why, recall that in the symmetric scheme, user authentication according to an embodiment of the present invention maintains a different shared secret with each site. In the public-key scheme, the site never stores the phone's secret key. Thus, in neither case does a compromise of one site affect another.

It is also worth noting that since the user never types in their password, an application according to an embodiment of the present invention protects users against present day keylogging malware installed on the user's PC.

Offline phishing is addressed here. An offline phishing attack refers to a phisher who sets up a static spoofed web site and then waits for users to authenticate at the site. The term “offline” refers to the fact that the phisher scrapes the target web site's login page offline. For sites using password authentication, an offline phisher obtains a list of username/password that can be sold to others. It should be noted that users who fall victim to this attack typically ignore information displayed in the address bar. Consequently, the SSL lock icon or the extended validation colors in the address bar do not prevent this attack.

User authentication according to an embodiment of the present invention prevents offline phishing since the phisher does not obtain a credential that can be used or sold. In fact, the offline phisher gets nothing since the phone sends its response directly to the target web site. Recall that during account creation, an application according to an embodiment of the present invention records the target web site's address on the phone. During login, it sends the response to that address. Consequently, the offline phisher will never see the response.

Online phishing is now addressed. Online phishing is an example of an active man in the middle attack. The end result of the attack is that the phisher's browser is logged into the user's account at the target site. As in the offline phishing case, reliance cannot be placed on security indicators in a browser (e.g., Chrome or Firefox) to alert the user to this attack. As discussed above, an embodiment of the present invention uses geolocation to defend against this attack.

It is also worth noting that this attack is easily defeated using a browser extension. The extension retrieves the SSL session key used in the connection to the web site (e.g., the phishing site) and embeds a hash of this key in the QR code (if the connection is in the clear the data field would be empty) along with the extension's digital signature on the hash. The phone verifies the signature and then sends the hash to the real site along with its response to the challenge. The web site would now see that the browser's SSL session key (used to communicate with the frontend of the phishing server) is different from its own SSL key (used to communicate with the backend of the phishing server) and would conclude that a man in the middle is interfering with the connection. A reason for the extension's signature on the hashed key is to ensure that the phisher cannot inject its own QR code onto the page with the “correct” key in it. An alternative to a digital signature is to place the QR code containing the hashed key in the browser chrome (e.g. in the address bar) where the phisher cannot overwrite it with its own data.

Key revocation is now addressed. If a phone is lost or stolen, such phone can potentially be used to impersonate the user at all websites where the user has an account. User authentication according to an embodiment of the present invention mitigates this issue in two ways. First, the application according to an embodiment of the present invention can requires the user to authenticate to the phone before the application can be used. Instead of implementing an unlock feature, the phone's locking mechanism is used for this purpose in an embodiment. Users who worry about device theft can configure their phones to require a pass code before an application can be launched. This forces a thief to first override the phone's locking mechanism. Moreover, a remote kill feature can be implemented to destroy data on the phone in case it is lost or stolen. Secondly, when a phone is lost, users can easily revoke the credentials on the phone by visiting web sites where they have an account and resetting their credentials at those sites. This results in a new keying material generated for the user thus invalidating the secrets on the lost phone.

### Implementation

User authentication according to embodiments of the present invention includes actions by a provider and a mobile client, for example. The provider and the client provide a reference implementation for the server and client ends of the protocol, respectively.

In an embodiment, the provider is implemented as a custom OpenID provider and offers server-side challenge/response functionality as described above. OpenID is a popular protocol for federated identity management and single sign-on. With the addition of this layer of indirection, many existing OpenID consumer web sites are able to use embodiments of the present invention without requiring modification of their server-side login protocols.

In an embodiment, the provider implementation makes use of the Joid open source project and is written in Java, which is loosely coupled to Joid. Joid can, therefore, be plugged into other standard OpenID providers. The custom provider consists of a symmetric-key based challenge response system, account management, and a web portal. In an embodiment, the challenge response modules are written in Java using built-in cryptography libraries. Such embodiment includes modules for symmetric key generation, and HMAC-based challenge/response creation and verification. The account management modules manage user accounts, provide persistence and include a cache for fast lookup of incoming responses.

The web portal according to an embodiment adds QR code features to the OpenID provider. The web portal includes custom registration and login pages, implemented as Java Server Pages (JSP) to support the account creation and login protocol according to an embodiment of the present invention. On completion of the login protocol, the web portal integrates with the provider backend to signal the result using the OpenID protocol. This enables existing OpenID consumer sites to support embodiment of the present invention with little or no code changes. In an embodiment, the provider module has approximately 1,600 source lines of code (SLOC).

A mobile client according to an embodiment of the present invention is written in Java for the Android environment. Such mobile client implements the client-side protocol and offers functionality for credential management and symmetric key challenge/response computation. In an embodiment, Android's SharedPreferences API was used to store and manage credentials retrieved from the provider. In an implementation, the credentials are managed using a secure credential manager. The login module uses built-in APIs to compute responses to challenges. Android's intent system and the ZXing project were used to scan and consume QR codes. For improved security, the scanning functionality will be embedded directly in the application. The mobile client has approximately 400 SLOC.

An application according to embodiments of the present invention involves multiple devices interacting to perform a common task. The Junction platform was used for device pairing and messaging in a multiparty session.

In an embodiment of the present invention, the session contains agents representing a server, a mobile device, and a web page. The server instantiates a Junction session, generating a unique session identifier. The server then passes the identifier to the web page, which then executes Javascript code to join the session. The web page also encodes this session identifier in a QR code. After scanning the QR code, the mobile client joins the session and begins the transaction in an embodiment. With Junction, messaging occurs asynchronously. Junction uses XMPP for its messaging infrastructure, with the BOSH extension supporting messaging to standard web clients.

Embodiments of the present invention provide an easy-to-use authentication system that defeats many of the attacks on traditional password schemes on the web. User authentication according to an embodiment of the present invention is implemented as a custom OpenID provider, enabling usage on the tens of thousands of websites that accept OpenID-based authentication, without much, if any, server-side code changes. In an embodiment, the OpenID protocol has been extended so that the user can simply take a picture of a QR code presented by a relying party without having to enter user credentials on the login page.

A payment process according to an embodiment of the present invention allows consumers to use one-time credit card numbers with a photograph of a QR code. One-time credit card numbers are useful for reducing the risk of interacting with small retailers or questionable sites on the Internet. Embodiments of the present invention eliminate the manual labor involved. Embodiment of the present invention can be implemented in other payment schemes, including Verified by Visa and MasterCard SecureCode, for example, to improve usability an security.

User authentication according to an embodiment of the present invention can be used in an off-the-shelf PC browser with little or no modifications, and works well with many popular browsers today.

Payment processes according to embodiments of the present invention allows consumers to make purchases using their camera-equipped smartphone. An embodiment allows for payments on e-commerce sites. With a payment process according to an embodiment of the present invention, a merchant can embed a button during checkout that grants the consumer easy and quick mobile checkout. With a payment process according to an embodiment of the present invention, the user (1) clicks the “mobile checkout” option in a browser, (2) the website presents a two-dimensional barcode, (3) the user scans the barcode with their smartphone, and (4) the user enters their PIN and confirms the purchase on their phone.

Filling out a form on a mobile device is a high-friction interaction. This hurdle can be eliminated in an embodiment as follows. When a user scans the payment QR code for the first time, the user is told that an account has not been established. Check out on the website can proceed as usual, and the account can be synchronized to the phone. The user begins entering his details on the e-commerce site and immediately sees the account populated on the phone.

When the account has been populated with, for example, name, billing address, credit card number, the account is stored in encrypted form on the associated servers. The encryption key resides on the user's device, and must be combined with a PIN for access. If too many incorrect attempts are detected to access the credentials with bad PINs, an account can be locked. And, without the PIN and encryption key stored on the phone, even a system administrator may not be able to access the consumer's payment credentials.

The present invention provides value to the parties involved in a financial transaction, including:
Consumer: Fast checkout across the web without storing private data with each merchant they may visit.
Merchant: Reduced shopping cart abandonment by enabling rapid checkout with reduced liability and infrastructure costs associated with storing payment data potentially reduced processing fees the overhead in implementing a payment process according to an embodiment of the present invention is minimal.
Issuer: Improved security afforded by using an active, online device for payments rather than a static credit card (discussed below).
   To facilitate adoption of the present invention, it should preferably be easy to integrate for merchants, and easy for consumers to use.

While the forgoing is directed to embodiments of the present invention, other and further embodiments of the invention may be devised without departing from the basic scope thereof. For example, aspects of the present invention may be implemented in hardware or software or in a combination of hardware and software. One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored. Such computer-readable storage media, when carrying computer-readable instructions that direct the functions of the present invention, are embodiments of the present invention.

We claim:

1. A computerized method for authenticating security credentials, comprising the steps:
receiving a request for authentication from a first computer;
generating information for an optically recognizable code, wherein the optically recognizable code includes authentication information;
transmitting the information for the optically recognizable code to the first computer configured to interpret the information for the optically recognizable code;
receiving a message from a camera-equipped user device, wherein the message includes information responsive to the authentication information;
confirming that the received message is responsive to the transmitted information; and
providing authentication to the first computer.

2. The method of claim 1, wherein the optically recognizable code is a QR code.

3. The method of claim 1, wherein the authentication information includes an encryption key.

4. The method of claim 1, wherein the authentication information includes a symmetric key.

5. The method of claim 1, wherein the authentication information includes a public key.

6. The method of claim 1, wherein the information responsive to the authentication information is a hash of a plurality of information including at least a portion of the authentication information.

7. The method of claim 1, wherein the camera-equipped user device is a smart phone.

8. The method of claim 1, wherein the camera-equipped user device is a tablet computer.

9. The method of claim 1, further comprising completing a transaction responsive to the authentication.

10. The method of claim 9, wherein the transaction is completed with a one-time credit card number.

11. A computerized method for authenticating security credentials, comprising the steps:
receiving a request for authentication from a first computer;
generating information for an optically recognizable code, wherein the optically recognizable code includes authentication information;
transmitting the information for the optically recognizable code to the first computer configured to interpret the information for the optically recognizable code;
receiving a message from a camera-equipped user device, wherein the message includes information responsive to the authentication information;
confirming that the received message is responsive to the transmitted information; and
providing authentication to the first computer.

12. The method of claim 11, wherein the optically recognizable code is a QR code.

13. The method of claim 11, wherein the authentication information includes an encryption key.

14. The method of claim 11, wherein the authentication information includes a symmetric key.

15. The method of claim 11, wherein the authentication information includes a public key.

16. The method of claim 11, wherein the information responsive to the authentication information is a hash of a plurality of information including at least a portion of the authentication information.

17. The method of claim 11, wherein the camera-equipped user device is a smart phone.

18. The method of claim 11, wherein the camera-equipped user device is a tablet computer.

19. The method of claim 11, further comprising completing a transaction responsive to the authentication.

20. The method of claim 19, wherein the transaction is completed with a one-time credit card number.

21. A computing device comprising:
a data bus;
a memory unit coupled to the data bus;
a processing unit coupled to the data bus and configured to receive a request for authentication from a first computer;
generate information for an optically recognizable code, wherein the optically recognizable code includes authentication information;
transmit the information for the optically recognizable code to the first computer configured to interpret the information for the optically recognizable code;
receive a message from a camera-equipped user device, wherein the message includes information responsive to the authentication information;
confirm that the received message is responsive to the transmitted information; and
provide authentication to the first computer.
